(19) United States
(12) Patent Application Publication
(10) Pub. No.: US 2013/0006750 A1
(43) Pub. Date: Jan. 3, 2013

(54) CONSUMER CREATED COUPONS

(76) Inventor: Lawrence David Simmons, JR., Edina, MN (US)

(21) Appl. No.: 13/549,973

(22) Filed: Jul. 16, 2012

Related U.S. Application Data
(63) Continuation-in-part of application No. 13/285,812, filed on Oct. 31, 2011.
(60) Provisional application No. 61/410,225, filed on Nov. 4, 2010.
(60) Provisional application No. 61/418,734, filed on Dec. 1, 2010.

(51) Int. Cl. G06Q 30/02

(52) U.S. Cl. 705/14.39

(57) ABSTRACT

Apparatus and a method create on-line obtainable coupons. The apparatus includes at least a first server enabling communication with a first class of third party on-line communicators. The first server receives proposed content on coupons from the first class of third party communicators, such as consumers, vendees and service users. The first server posts a list of proposed coupons, with or without modification of the proposed coupons after receipt from the first class of third-party on-line communicators. The server then enables access to the server to a second class of third party communicators. The server allows members of the second third party communicators to approve or disapprove of proposed coupons that are dedicated to business. This approval may be based on response in the form of voting, requests, a tally of positive and negative comments, or any other indicator that shows consumer interest in a proposed coupon.

### RELATED APPLICATION DATA

This Application is a Continuation-in-Part of U.S. application Ser. No. 13/285,812 filed 31 Oct. 2011, which in turn claims priority from both U.S. Provisional Applications, Ser. Nos. 61/410,225 filed 4 Nov. 2010 and 61/418,734 filed 1 Dec. 2010.

### BACKGROUND OF THE INVENTION

1. Field of the Invention

The present invention relates to the field of coupons, the provision of coupons by vendors or merchants, and the provision of coupons through web-based services.

2. Background of the Art

The use of coupons significantly benefits both consumers and vendors by saving money for the consumers and increasing draw into a vendor's facility by the attraction of coupon available discounts on specific items. Coupons have long been available in magazines and newspapers for distribution to the public. As the use of magazines and newspapers have declined over the years, alternative methods of making coupons available have been required.

Coupons may be provided on line by direct mailing (physical mail or e-mail) from vendors or merchants or may be available from specific services that offer access to coupons at either specific stores, specific on-line services (mail order, e-mail order services, etc.), or on specific products at any location.

It is desirable to develop an additional method of providing coupons or discounts to consumers that would generate improved rates of coupon usage and minimize the provision of coupons with little commercial impact.

### SUMMARY OF THE INVENTION

Apparatus and a method using the apparatus to create on-line obtainable coupons are described and enabled. The apparatus includes at least a first server enabling communication with a first class of third party on-line communicators having user inputs. The first server receives proposed content on coupons from the first class of third party communicators, which may be consumers, vendees, service users and the like. The first server posts a list of proposed coupons, with or without modification of the proposed coupons after receipt from the first class of third-party on-line communicators. The server then enables access to the server to a second class of third party communicators, which may be businesses including at least vendors, stores, warehouses, manufacturers, distributors, retailers, wholesalers and material suppliers. The server allows members of the second third party communicators to approve or disapprove of proposed coupons that are dedicated to business of the second third party communicator. This approval may be based on response (especially from the first class of third-party on-line communicators) in the form of voting, requests, a tally of positive and negative comments, or any other indicator that shows consumer interest in a proposed coupon. The access to the consumer response is enabled by posting any second third party communicator coupons. The server may accept second third party on-line communicator approval of one or more coupons and make them available to first third-party on-line communicators. The server then allows all on-line communicators access to approved coupons so that any on-line communicators may access downloadable or printable forms of approved coupons.

### BRIEF DESCRIPTION OF THE FIGURE

FIG. 1 illustrates one embodiment of a coupon delivery system.

### DETAILED DESCRIPTION OF THE INVENTION

Apparatus and a method using the apparatus to create on-line obtainable coupons are described and enabled. The apparatus includes at least a first server enabling communication with a first class of third party on-line communicators having user inputs. The first server receives proposed content on coupons from the first class of third party communicators, which may be consumers, vendees, service users and the like. The first server posts a list of proposed coupons, with or without modification of the proposed coupons after receipt from the first class of third-party on-line communicators. The server then enables access to the server to a second class of third party communicators, which may be businesses including at least vendors, stores, warehouses, manufacturers, distributors, retailers, wholesalers and material suppliers. The server allows members of the second third party communicators to approve or disapprove of proposed coupons that are dedicated to business of the second third party communicator. This approval may be based on response (especially from the first class of third-party on-line communicators) in the form of voting, requests, a tally of positive and negative comments, or any other indicator that shows consumer interest in a proposed coupon. The access to the consumer response is enabled by posting any second third party communicator coupons. The server may accept second third party on-line communicator approval of one or more coupons and make them available to first third-party on-line communicators. The server then allows all on-line communicators access to approved coupons so that any on-line communicators may access downloadable or printable forms of approved coupons.

The technology also may include a computer readable medium that stores instructions, which when executed by a computer, causes the computer to deliver a coupon online, said instructions to the computer for:

storing information, into a coupon delivery system,
to specify at least one specific vendor and/or or product for a coupon,
to allow at least one computer to accept form at least one consumer a suggestion online for at least one specific coupon desired by the consumer,
to allow the at least one computer to accept approval by the specific vendor or distributor or manufacturer of the product authorization to enable online access to the specific coupon, and
to allow online access to the at least one computer to download a coupon or verify access to the coupon for a consumer.

The technology may further include a method of:

storing information on at least one processor in a coupon providing system;
the information allowing:
   a) at least one unavailable coupon proposed by a consumer or vendor;
   b) allowing consumers to provide commentary on a perceived desirability of the unavailable coupon;
   c) allowing a vendor, supplier or manufacturer of a product described in the coupon to authorize availability of the coupon; and
   d) upon receipt of authorization by the vendor, supplier or manufacturer, enabling online access for a download of the coupon or storing verification of availability of the authorized coupon when accessed by or on behalf of a consumer.

The present technology involves Internet consumers creating and recommending promotional offers, coupons, discount or goods and services to the respective merchant via the Internet into a database which can be later displayed on a webpage or a mobile device. The invention also involves the ability for other users to vote or rally behind existing users coupons thereby creating a tally from which the merchants can review. Once that coupon is electronically submitted it remains in pending status until the merchant approves it for in-store or online redemption.

In one embodiment the coupon system 142 is adapted based on content and programs downloaded. The download-history-adapted coupon system 142 may be an implicit query 164, an active query, a disambiguation action, a retrieval function, a filtering function, a presentation function, a routing function, or another function or action relating to the initiation, processing, or completion of a search. Downloaded content and programs may be determined from a database of general characteristics (e.g., AOL users, Earthlink users, Internet Explorer users, and the like), consumer characteristics or names, or subscriber characteristics 112, such as based on cellular phone usage, computer usage, Blackberry users, PDA users, iPhone users, Internet usage, email usage or the like. Such content and programs may be analyzed and used in the manner described herein for usage pattern-adapted coupon systems 142. In one such embodiment the coupon system 142 is adapted based on specific stores (Shmata Discount Market), specific online sites, specific manufacturers (Shmata Inc.), specific lines of products (e.g., all Shmata brand facial products), specific product areas (e.g., all toothpaste). Again, the content-action-adapted coupon system 142 may be an implicit query 164, an active query, a disambiguation action, a retrieval function, a filtering function, a presentation function, a routing function, or another function or action relating to the initiation, processing, or completion of a search. In another such embodiment the coupon system 142 is adapted based on input from both consumers and suppliers/vendors/manufacturers. The consumers and suppliers/vendors/manufacturers—adapted coupon system 142 may be an implicit query 164, an active query, a disambiguation action, a retrieval function, a filtering function, a presentation function, a routing function, or another function or action relating to the initiation, processing, or completion of a search.

In another such embodiment the coupon system 142 is adapted based on subscription to a specific distributor or supplier or store name or other business sponsoring the coupons or sponsoring the coupon system. In one such embodiment the coupon system 142 is adapted based on timing and duration of viewing/downloading and other indications by consumers of a degree of positive or negative interest in use of a specifically suggested coupon.

In embodiments, a method for using the coupon delivery system may include any online communication facility 102 may include providing a personal search filter, searching for information on a network using the mobile communication facility 102, or providing results based, in part, on the communication facility 102 location and the personal search filter. The personal search filter may reside within the communication facility 102, on a server, or on a network (e.g., the Internet). A personal search filter may be a collaborative filter and may also include at least two sub filters, such as filters related to personal information, business information, selectable filters, or filters based, in part, on the time of day or time of year. Personal filters may be configurable to include a local services search engine, a local product search engine, a business search engine, personal search engine, travel search engine, financial search engine, news search engine, video search engine, music search engine, and/or restaurant search engine. The mobile communication facility 102 may be a computer, PDA, Blackberry, iPhone, cell phone, satellite phone, combination PDA/cell phone, web device, and web appliance. The communication facility 102 may include an SMS search interface, a voice recognition search interface, or wireless applications protocol. The search may be performed, in part, through a carrier website or through a carrier partner's website.

Any operating system component would be an executable program component facilitating the operation of the Information Comparator system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh® OS, Microsoft® DOS, Microsoft Windows® system 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Information Comparator system controller to communicate with other entities through a communications network. Various communication protocols may be used by the Information Comparator system controller as a subcarrier transport mechanism for interaction, such as, but not limited to: multicast, TCP/IP, UDP, unicast, and/or the like.

### Information Server

An information server component used preferably as the computer in the above described methods and apparatus is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Information Comparator system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across a port, and/or the like. An information server may communicate to and/or with other components in a component collection, including itself, and/or facilities of the like. Most frequently, the information server communicates with the Information Comparator system database, operating systems, other program components, user interfaces, Web browsers, and/or the like.

Access to the Information Comparator system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Information Comparator system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Information Comparator system as a query. Upon generating query results from the query, the results are passed over the bridge mechanism, and may be parsed for formatting and generation of a new results Web page by the bridge mechanism. Such a “new results” Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Information Comparator system enabled nodes. The combined application may be nugatory on systems employing standard Web browsers.

### Mail Server

A mail server component is a stored program component that is executed by a CPU. The mail server may be a conventional Internet mail server such as, but not limited to sendmail,

Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Information Comparator system.

A coupon provision network typically integrates entities, such as consumers, manufacturers, suppliers, vendors, consumer outlets and the like. A coupon providing network typically operates in conjunction with suppliers and the like to deliver coupons, from one or more suppliers, vendors, consumer outlets, manufacturers advertisers, to consumers or tomcard clubs which enable access by consumers to a central database of coupons that have been enabled or authorized, with identification of the consumer to the central database of the card club needed to enable the use of the coupon. For example, Shmata manufacturing Inc. and its outlet stores, may operate such a coupon club and/or accessing network.

An integrator network entity generally defines a participant of the advertising exchange system that represents or integrates one or more entities on the coupon providing system. For example, an integrator network may represent advertisers on the coupon providing system in order to deliver coupons from vendors to consumers or other integrator networks. In some embodiments, the integrator networks are referred to as the “users” of the coupon providing system. The integrated networks may comprise third party agents that operate on behalf of or are part of the integrator network. The term “third party agent” is used to generally describe an agent or customer that participates in transactions on the coupon providing system. Similarly, the term “third party recipient” is used to describe a user or participant of the coupon providing system that receives information from the system, such as coupon requests. However, the terms integrator networks, third party agents and third party recipients is intended to represent a broad class of entities, including all commercial parties that sell, lease, rent, provide services and the like, as well as the agents that represent them, that operate on the coupon providing system.

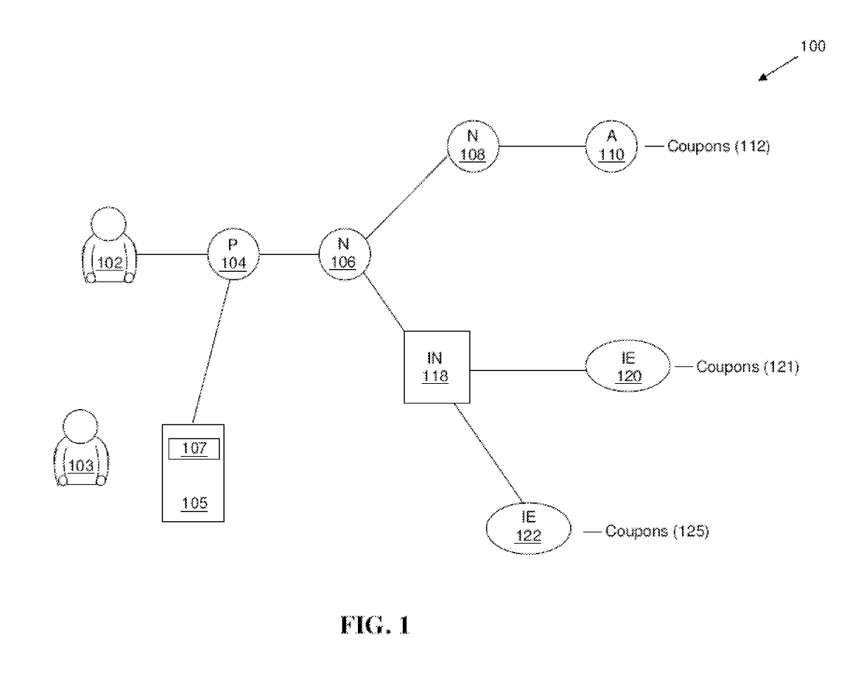

FIG. 1 illustrates one embodiment of a coupon delivery system. As shown in FIG. 1, the system 100 includes a variety of entities such as users 102 and 103, one or more manufacturers/publishers 104, networks 106 and 108, and/or advertisers 110. The system 100 further includes one or more integrator networks (IN) 118 that have one or more integrated entities (IE) 120 and 122. The various entities including all the types of consumers and vendors described above, integrator networks and integrated entities illustrated in FIG. 1 are merely exemplary, and one of ordinary skill recognizes that the system 100 may include large numbers of entities. Moreover, the various entities are coupled together in different advantageous configurations such as, for example, the exemplary configuration illustrated in FIG. 1.

The user (e.g., a consumer) 103 accesses information and/or content provided by the server 104. One form of access may include a browser 105 that has inventory locations 107 for the presentation of providing descriptions of coupons. In one embodiment, a coupon posting is generated that requests approval of the proposed coupon by an authorizing party and then subsequent voting on the proposed coupon by other consumers and the authorization and posting of an authorized coupon such as 112, 120 and 121, for placement with the coupon inventory location 107. The corresponding coupon may be delivered to consumer 104 by one or more networks. For instance, in one example, the network 106 is coupled to the consumer 104, and the network 108 is coupled to the vendor 110. For this example, the networks 106 and 108 are coupled to each other. The consumer 110 may have one or more suggested coupons each comprising one or more coupons 112 that the consumer 110 wishes to have placed with the inventory of coupons such as, for example, the inventory location 107 of the consumer 104 that is presented to the user 103 via the browser application 105.

Alternatively, and/or in conjunction with the embodiments described above, some embodiments direct an ad call for the inventory 107 to an integrator network 118. In one example, the ad call is passed from the network 106 to the integrator network 118 with additional information such as, for example, a geographic location for the destination of the advertisement. In the illustration of FIG. 2, one ad call may have a destination of San Francisco (SF), while another ad call may have a destination of Los Angeles (LA). Based on the ad call and/or information, the integrator network 118 selectively responds to ad calls for, or on behalf of, one or more of its integrated entities 120 and/or 122. The integrated entities 120 and 122 generally include third party entities, such as advertisers, that transact on the exchange by using an intermediary, such as the integrator network 118.

The client system may include a desktop personal computer, workstation, laptop, PDA, cell phone, any wireless application protocol (WAP) enabled device, or any other device capable of communicating directly or indirectly to a network. The client system typically runs a web browsing program that allows a user of the client system to request and receive content from server systems over a network. The client system typically includes one or more user interface devices (such as a keyboard, a mouse, a roller ball, a touch screen, a pen or the like) for interacting with a graphical user interface (GUI) of the web browser on a display (e.g., monitor screen, LCD display, etc.).

There is a particular need in the coupon industry for providing mechanisms for identifying clear value among coupon users and awarding established value for creators/providers of coupons on-line. There is also a desire to be able to identify “click fraud” where on-line providers receive payments for the number of users that click-on their advertising, and individuals repeatedly click on specific ads to elevate the numbers of clicks per advertisement or coupon and yet those clicks are valueless. Some of these issues can be addressed by additional technology included with the underlying practices of the present technology by software implementation to the apparatus and systems already described herein.

The use of “consumer quality scoring” services provides two significant underlying services to the technology described therein. Consumer quality scoring is an analysis of the actual performance of users within the present system. A scholastic (e.g., 1-10, based on established criteria) or percentage score (as later defined) is used to classify the quality of the user. One significant basis for characterizing “quality” for a user is rate determination with respect to on-line coupons or on-line advertising both clicked on and utilized. For example, an on-line user who clicked on seven advertisements or seven coupons and used three of those seven accessed items to purchase through those advertisements and/or use those coupons could be groups in a class artificially referred to herein as 3/7, 4.3, 4.3a or a scholastic rating of 4 (indicating a relatively low level of click-on usage (7 click-ons) but a significant rate utilization of the services accessed on-line. 3/7 is a specific identifier, 4.3 is an artificial scholastic rating approximating a 43% use rate of clicked on services, and 4.3a shows a similar utilization rate in as low volume category (e.g., a is fewer than 10 clicks/period, b would be 11-20 clicks for the same period, c would be 21-40, d 41 through 70, etc.) These types of categorizations of actual, scholastic, percentages of utilization tied to volume of use can be used to characterize or grade the quality of the user and/or the coupon or advertisement.

For further example, if a coupon is clicked on 1 million times and only 3 coupons are used, that would tend to indicate a low quality rating for the coupon, and might be indicative of click fraud, as described herein. A coupon with only 10,000 clicks but 400 users indicates a service that is of identifiable value to the service provider. The low level of total usage may reflect positioning of the advertisement on a particular venue and might further be used as an indicator that the improvement of the positioning might result in a further increase of clicks on a service with a respectable use rate.

This type of coupon or advertising providing format provides the advertiser greater visibility on the type of traffic (customer) they are bidding on in their on-tine activities. This can be used in pricing or payment formats because of the easier identification of values and quality associated with specific service presentation and use and users.

This type of system also shows the advertiser whether or not the customer has a history of just clicking on ads but not buying or clicking on an ad and actually completing a purchase.

One way of describing the functioning of this process implementation on the apparatus or system described herein is as follows.

All registered users of the advertising network are given an initial quality score (e.g., for purposes of discussion this may be considered as a score of one (1)). Quality scores are based on a user's click or rally with respect to purchase history. If a user clicks on an ad or rallies a coupon and completes a purchase their quality score will go up accordingly. If a user clicks or rallies and ad and doesn't complete a purchase the users quality score will go down with respect to the initial, provisional score (in this case one was used as the example).

The uses and advantage of having a high quality score on the network is that the higher quality score gives the user more credibility and a higher probability a creator's or merchandiser's coupons will be approved. Furthermore, merchants or advertisers would be more willing to give the higher quality scoring on-line users exclusive offers and deeper discounts.

Another use of this additional technology is establishing a payment basis for coupon creators. These creators would be more active within the framework of the system if there were a basis for establishing not only a high rate of clicks on their proposed coupon, but also a determinable rate of usage of the coupons, establishing higher value to the merchandiser or provider. This can be done on the basis of specific qualities of advertisements being identified by one or more features such as percentage of users exercising the service (buying through the advertisement or using the coupon in a transaction), the percentage or volume of high quality score users accessing the advertisement or coupon, and the like.

The method, apparatus, system and computer readable medium described herein may also include quantification of quality of on-line communicators accessing coupons on a basis of comparing relative proportions of coupons used in a transaction by a specific on-line user as compared to a total number of coupons accessed by the specific user.

### Coupon Delivery by Phone or PDA

It is now commercially available delivery technology to have the coupons delivered to cell phones and/or PDAs or other hand-held devices having a viewing screen by such technologies as Delivery of tickets to mobile phones can be done in a variety of ways:
Text messaging (SMS)—visual inspection or OCR
Text messaging with WAP Push—visual inspection or OCR
Picture messaging (SMS, EMS, WAP Push and MMS)—usually uses a barcode, and especially a 2D or 3D bar code
Dedicated Mobile application—which can store and render barcodes delivered via SMS, GPRS, Bluetooth, IRDA or RFID. Barcodes rendered on the device by a dedicated application have the advantage of being full screen without clutter, meaning faster and more successful scanning. A dedicated mobile application can also help the user to organise and sort their tickets better than when an SMS or MMS inbox is full of similar tickets, which is especially useful for transport tickets.
Device RFID—This is the method proposal under the Near Field Communication (NFC) specification but not yet in general use

Among the available commercial technologies that can effect this delivery of coupons according to the disclosed technology of the present invention include the following technologies now available for airline ticket delivery:

### Solutions

| | Delivery | Scanning | Validation | | | |
|---|---|---|---|---|---|---|
| Company | Method | Method | Method | Advantages | Disadvantages | Location |
| Bissano Soft- | Barcode-based EMS | Barcode scanner, | | The solution includes | Investment for | Offices: Sofia/ |
| ware ltd | or MMS. The solu- | integrated ther- | | Barcode 1D and 2D and | scanner devices. | Bulgaria, |
| | tion includes | mal printer | | PDA software and Back | | Brisbane/Au- |
| | Barcode | | | Office system. PDA com- | | stralia |
| | 1D and 2D. | | | municate with BO via | | |
| | | | | WiFi/GPRS connection. | | |
| | | | | The solution is used to | | |
| | | | | sales tickets on move. | | |
| Mobile Tickets | In-Mobile Appli- | Providers of | Remote or | World wide delivery | Consulting on | Offices based in |
| Ltd | cation, Barcode 1D | the first ever | local server . . . | possible, secure & | Mobile Tickets, | London (UK), |
| | and 2D delivered | Twitter to Mo- | also working | customizable | Banking and | with partners in |
| | via secure encrypted | bile Barcode | on Mobile | | Payments, also offer- | Europe, Asia |
| | SMS or GPRS, | delivery solu- | Tickets in | | ing solutions for the | and North America |
| | using a 3kb | tion | Facebook | | purchase of turnstiles, | |
| | Java Platform | | App | | scanner and kiosk | |
| | | | | | equipment required | |
| | | | | | for Mobile Ticketing | |
| bCode | Text-based SMS. | Electronically | Remote or | Secure, reliable, strong | Investment for | Australia, |
| | | (camera). | local server. | device support, dy- | scanner devices | United States |
| | | | | namic user experience. | | |
| codeREADr | Barcode: 1D and | Embedded data | Remote server. | Secure, fast. For | Requires iOS, | Worldwide. |
| | 2D print or mobile. | validated on- | | budget-conscious | Android or BB de- | |
| | | device or online | | (scanner already in | vice at point of entry. | |
| | | | | pocket). | | |
| Eagle Eye | Text-based SMS as | Customer types | Central server | Secure real time re- | Integration into | Worldwide. |
| Solutions | response to text in, | unqiue code into | lookup utili- | demption of ticket. | Chip and PIN | |
| Limited | text push, W AP | kiosk, PDA or | sing either | Capture of signi- | system. PDA or | |
| | Purchase. | Chip and PIN | internet or | ficant customer data. | kiosk rental | |
| | | handset. | existing | Utilises existing Chip | costs. | |
| | | | financial | and PIN technology | | |
| | | | networks. | for ticket code cap- | | |
| | | | | ture and data trans- | | |
| | | | | fer. Unique and multi | | |
| | | | | use tickets available. | | |
| GEAR.it | Barcode-based | Codes validated | Remote or | Secure, live voucher, | Rental of or | Italy |
| | MMS, SMS, | with mBARC/ | local server. | integrated marketing | investment for | |
| | Email | Newland scan | Integration | services, fraud pre- | scanner devices. | |
| | | engine. | with proximity | vention. API integration | | |
| | | | couponing via | into existing systems | | |
| | | | Bluetooth own | | | |
| | | | servers. | | | |
| Gavitec AG | Barcode-based | EXIO & MD-20 | Remote or | Secure, wide-reach, | Rental of or | Worldwide |
| | SMS, EMS or | barcode scanners | local server. | strong device support, | investment for | |
| | MMS. | | | integration with | scanner devices. | |
| | | | | ticketing. CRM and | | |
| | | | | access management | | |
| | | | | solutions. | | |
| Impact Mobile | Barcode-based | Off-the shelf | Remote or | Secure. API to | No visual | |
| | SMS w/WAPpush | image scanner. | local server. | integrate to existing | validation. | |
| | or MMS. | | | ticketing solutions. | Investment for | |
| | | | | | scanner devices. | |
| | | | | | Problem with | |
| | | | | | several phone | |
| | | | | | models. High | |
| | | | | | telecom costs of | |
| | | | | | MMS messages. | |
| INA Finland | Text-based SMS, | Visually/ | INA secure | No investment for | Investment in | Tampere, Finland. |
| | w/WAPpush. | validators. | server and/or | scanner devices, | scanner devices | (service worldwide) |
| | | | local server. | although imple- | required if exist- | |
| | | | | mentation possible. | ing units cannot | |
| | | | | Secure control code | be used. | |
| | | | | system for visual | | |
| | | | | validation, optional | | |
| | | | | extra verification by | | |
| | | | | phone. No settings or | | |
| | | | | pre-registration need- | | |
| | | | | ed, single SMS. | | |
| | | | | Secure and easy. | | |
| InMoDo (M- | Text-based SMS, | Imager/Camera- | Remote or | Secure, reliable, | Investment in | Sweden, Europe, |
| PhaTic) | barcode 1D and | based scanners. | local server | strong device support, | scanner devices | worldwide |
| | 2D, RFID | | as ticket code | range of scanners for | required if exist- | |
| | | | contains full | different use-cases, | ing units cannot | |
| | | | information | including handheld | be used. | |
| | | | | units from well- | | |
| | | | | known brands, no | | |
| | | | | phone settings or pre- | | |
| | | | | registration required, | | |
| | | | | single SMS. | | |
| Liquid Bar- | Barcode. (SMS, | Off-the shelf | Remote or | World wide delivery, | | Norway |
| codes | MMS, WAP, | barcode scanner | local server | secure, visual ID | | |
| | NOKIA SMART, | | | included, optimised | | |
| | EMS). Airline | | | 1D and 2D barcodes | | |
| | Tickets/2D Barcode | | | tailered to the mobile | | |
| | | | | to ensure successful | | |
| | | | | scanning | | |
| Masabi | Dedicated mobile | Any 2D barcode | Encrypted | Secure ticket purchase | Mobile application | United Kingdom, |
| | application, usually | scanner, includ- | barcode | and delivery from the | must be installed | Worldwide deploy- |
| | Java Platform, Micro | ing using other | contents | mobile, without any | on phone by the | ments |
| | Edition, barcode | mobile phones | enable off- | sign-up process or | user or the operator | |
| | tickets delivered via | as the inspec- | line valida- | passwords. More | | |
| | encrypted SMS or | tion device | tion without | reliable barcode | | |
| | GPRS | | synchroni- | scanning because of | | |
| | | | sing ticket | full-screen rendering | | |
| | | | databases onto | of the barcode. Barcodes | | |
| | | | the local scan- | delivered in a single | | |
| | | | ner, or on-line | SMS. | | |
| | | | validation. | | | |
| Micket Mobile | Barcode-based | Handheld QR | Remote or | Integration with | Rental of or | Worldwide |
| Ticket | SMS, MMS. | code scanners. | local server. | Facebook, Twitter. | Investment for | |
| | Encrypted/Plain | | | Secure and Encrypted, | scanner devices. | |
| | text QR code. | | | Mobile and Event | | |
| | | | | Ticketing Solutions | | |
| MBO | Barcode-based | Off the shelf | Remote or | Secure, live voucher, | Investment for | |
| | SMS, MMS, | image scanner/ | local sever | integrated market- | scanner devices. | |
| | WAP, Keyword | visually | | ing services, fraud | | |
| | Text- | | | prevention, API inte- | | |
| | In/Push/WAP | | | gration into existing | | |
| | Purchse/Secure | | | systems | | |
| | Interfaces | | | | | |
| Mobimatics | Barcode SMS | M-Scan Valida- | Caching | Removal of human | Investment for | |
| | 1D, 2D | tor 1D, 2D | GPRS | visual validation, | scanner devices. | |
| | | barcodes on | manifest | total fraud pre- | | |
| | | mobiles | downloads | vention | | |
| | | | stored on | | | |
| | | | local devices. | | | |
| Mobiqa | Barcode-based | Off-the shelf | Remote or | Secure, wide-reach, | | Worldwide |
| | SMS, WAP Push | barcode | local server. | visual ID included, | | |
| | or MMS. | scanner | | optimised barcode | | |
| | | | | tailered to the mobile | | |
| | | | | to ensure successful | | |
| | | | | scanning | | |
| Moo! Mobile | Barcode-based | 2D barcode | Remote or | Integrated branding | Phone model | Netherlands, |
| Technology | SMS, EMS, Nokia | scanner | local scanner | and marketing | required | Worldwide |
| | Smart, WAP Push | | | solution. Worldwide | | |
| | or MMS | | | delivery. API available. | | |
| | | | | Secure. | | |
| MogoTix | QR code-based | Validated using | Remote or | Self-service ticketing: | iPhone or Android | Worldwide |
| | ticket delivered | MogoTix | local server | event organizers can | phone required to | |
| | through SMS | iPhone or An- | | sign up to quickly sell | scan tickets | |
| | | droid apps | | mobile tickets to events | | |
| NTT DoCoMo | Online purchase, | RFID reader | Online | Secure RFID system | Not usable for | |
| (Osaifu- | downloaded to | (PaSoRi) | lookup | without visual | non-compliant | |
| Keitai) | RFID chip | | | scanning. | phones. Credit card | |
| | (Mobile FeliCa) | | | | registration needed. | |
| | | | | | Still often uses pap- | |
| | | | | | er ticket for confir- | |
| | | | | | mation. | |
| Plusdial | SMS text message | Visually (na- | Remote or | Patented control code | Investment for | Worldwide |
| | (one SMS is enough | ked eye) or | local server | system for visual | scanners needed | |
| | no need for e.g. | validators | | validation, tested with 2 | (but only if | |
| | binary SMS to | reading textual | | optional scanner/ | automatic | |
| | carry bar codes) | content | | validator systems. | validation is | |
| | | | | Operated since 2001 | required). | |
| | | | | with over 60 million | | |
| | | | | tickets sold. No invest- | | |
| | | | | ment needed when using | | |
| | | | | visual checking. As | | |
| | | | | textual SMS used, | | |
| | | | | system works in all | | |
| | | | | mobile phone models | | |
| | | | | without registration | | |
| | | | | or even data settings | | |
| | | | | requirements. Fixed | | |
| | | | | and handheld scanners | | |
| | | | | available; even an | | |
| | | | | Android smart phone | | |
| | | | | with camera and | | |
| | | | | downloadable | | |
| | | | | software can be used | | |
| | | | | as handheld valida- | | |
| | | | | tor. | | |
| ScreenTicket | SMS with link | PCT patent | Remote server, | On Device Verifica- | None | Global, based |
| | delivered to web | pending On | data necces- | tion ®, global delivery, | | out of Denmark |
| | based mobile | Device Veri- | sary | easy integration of | | |
| | tickets and cou- | fication ® and | | API, fast setup, secure | | |
| | pons, all options | dynamic ele- | | solutions | | |
| | available | ments on tickets | | | | |
| | | and coupons. | | | | |
| | | No scanners | | | | |
| | | needed | | | | |
| ShowClix | Delivers tickets | Off-the shelf | Remote | Rental of or in- | | United States |
| Ticketing | via SMS text | image scan- | server | vestment for | | |
| LLC | message | ner | | scanner devices | | |
| Sincoda | 2D barcode | 2D barcode, | Online | Open system-can | | United Kingdom |
| Limited | creation, delivery | NFC or RFID | lookup via | integrate with any | | |
| | and redemption. | via Sincoda | GPRS or | coupon/ticket/ | | |
| | Content sent via | terminal, op- | WiFi, local | loyalty programme. | | |
| | WAP and em- | tional printer | database or | Secure RFID/NFC | | |
| | bedded email | dock. Cus- | custom | reader with dual | | |
| | | tomized version | integration | SAM slots. Read paper | | |
| | | for car parks | | and mobile barcodes. | | |
| Skycore LLC | 2D barcode | Off-the-shelf | Local or | Cross carrier (US), | Investment in | U.S.A. Scalable |
| | creation, | 2D scanners | Remote | end-to-end, enter- | traditional 2D | worldwide with |
| | delivery, | and/or smart | Server. | prise solution; MMS | scanners or smart | connectivity. |
| | authentication | phones | | specialtist. API option. | phones. | |
| | and redemption. | authenticated | | | | |
| | Content sent via | to scan/read | | | | |
| | SMS/WAP Push | 2D barcodes. | | | | |
| | MMS and Email. | | | | | |
| Smartmachine | 2D-Barcode- | CCD-camera | Online or | Secure, strong device | Rental of or | Worldwide |
| | based SMS, | based barcode | local. | support, integration | investment for | |
| | WAP Push, MMS, | scanner, | | with ticketing. CRM | scanners needed | |
| | 2D-Barcode via | attached to an | | and access manage- | | |
| | Mail to | access control | | ment solutions. | | |
| | BlackBerry/ | reader or | | | | |
| | PDA, NFC. | built into a | | | | |
| | | kiosk. | | | | |
| Timoco | Barcode-based | Off-the shelf | Remote or | Secure, wide-reach, | Rental of or | Western Europe |
| | SMS, WAP Push | barcode | local server. | visual ID included. | investment for | |
| | or MMS. | scanner, custom | | | scanners needed. | |
| | | built barcode | | | | |
| | | scanners | | | | |
| | | (1D, 2D) | | | | |
| Trinity Mobile | Barcode (SMS, | Barcode reader, | Online | Removal of human | Investment for | |
| Limited | MMS, WAP, | PDA or Kiosk | lookup, local | visual validation, | scanner devices. | |
| | NOKIA, EMS). | | server or | unqiue one time use | | |
| | Keyword Text- | | trickle fed | codes, total fraud | | |
| | In/Push/WAP | | PDA | prevention. Free | | |
| | Purchase/Secure | | database. | software | | |
| | Interfaces | | Wifi and | | | |
| | | | GPRS | | | |
| tyntec | Barcode. (SMS, | Any 2D | Online, | Secure. Worldwide | Investment for | Worldwide |
| | MMS, WAP, | barcode | remote or | availability. Highest | scanner devices. | |
| | NOKIA | scanner | local. | privacy protection | | |
| | SMART, EMS). | | | through end-to-end | | |
| | Airline Tickets/ | | | control over the | | |
| | 2D Barcode | | | entire GSM delivery | | |
| | | | | path. Strong device | | |
| | | | | support. Strategic | | |
| | | | | partnership with | | |
| | | | | IATA for mobile | | |
| | | | | boarding passes. | | |
| Pyrumas | Barcod. (SMS, | Any 2D | Online, | Secure. Indian | Investment for | India, Bangalore, |
| Software Pvt. | MMS, WAP, | barcode | remote or | Connectivity. | scanner devices. | Chamrajpet. |
| Ltd | NOKIA | scanner | local. | Highest | | |
| | SMART, EMS). | | | privacy | | |
| | Airline Tickets/ | | | protection | | |
| | 2D Barcode | | | through end- | | |
| | | | | to-end control | | |
| | | | | over the entire | | |
| | | | | GSM | | |
| | | | | delivery path. | | |
| | | | | Strong device | | |
| | | | | support. | | |
| Unwire | SMS, smartphone | Visual, code | Online, | No sign-up needed, | Investment for | Europe |
| | apps and mobile | lookup and | remote or | multiple payment | scanner devices | |
| | web | imager/ | local | methods, strong | | |
| | | camera-based | | device support, highly | | |
| | | scanners | | flexible ticket pro- | | |
| | | | | duct types | | |
| Wayin | 1D and 2D | Off-the shelf, | Remote or | Secure, live voucher, | Investment for | South Africa |
| Solutions | Barcode-based | cutom built | local server | integrated marketing | scanner devices. | |
| | message | barcode | | services, fraud pre- | | |
| | (SMS, MMS, | scanners | | vention, API integration | | |
| | EMS, WAP and | (1D, 2D) | | into existing sytems, | | |
| | EMAIL(Optional | | | rental of scanner units | | |
| | for Smartphones). | | | available (South | | |
| | | | | Africa Only) | | |
| WapOneline | SMS, WAP & | Premium and | Purchase | World wide delivery | Investment | Offices: Finland, |
| | Mobile Web | Standard Rate | Conf# or | possible, secure & | required for | USA, Latin |
| | Interfaces | SMS Connec- | Barcode | customizable | customization | America |
| | | tions to 30+ | delivered to | | and messaging | |
| | | Carriers | handset | | service | |
| www.mTicket. | Text base SMS | Handheld units | Remote or | White label solution. | Need to buy | EU base and soon |
| co | 100% compa- | IPhone, | local server | No phone settings or | IPhone, Android, | Worldwide Partner. |
| | tible with all mobile | Android, | valudation. | pre-registration | Ikön, Motorola. | DataTEK Group, |
| | handsets. No need | Motorola, | WiFi, 3 G. | required, only SMS. | | Inc.-Romania. |
| | additional software | Ikön. Smart | Easy inte- | Secure, strong | | |
| | to install on the | camera image | gration of | and reliable device | | |
| | phone | scanner. | api. | support. | | |

In the practice of the present technology, additional features may be practiced on the described apparatus as additional features in the practice of the generic methods described herein. It is to be noted that one aspect of the present technology allows a customer site to create an initially rally or new coupon which other customers or customer sites may contribute or purchase (the coupons). The creation of the coupon and/or a site where that coupon is available is known in the art as a rally. The purchase of coupons in each rally (each coupon created by or referenced by a specific customer site) is traceable within the system by identifying locations, GUIs, cookies, tags, addresses, and other tracking mechanisms well understood within the on-line industry. For example, A rallier (the customer site creating or referring a specific coupon) is identified by a unique ID which is generated during time of complete registration. If the user site creates a rally a site ID (e.g., his or her ID) is associated with the rally through conversion to coupon process and execution of a sale using the coupon.

As in the generic processes described herein, a central server makes an accounting and record of all transactions and event and monitors creation and purchase of coupons. In this additional process step using this equipment, the main server executes a bookkeeping function to to track and associate all coupon purchases and exercise of coupon exchanges on rallies created or extended by single customer sites through the traceable function described above. This process step operates as follows, with a number of optional steps available in its use.

A user site (a distal processor/server in communication with the main central server site) creates a coupon and attendant rally or extends an existing rally through communications from or access to the user site. For example, a social network user may find what is perceived to be a particular high quality coupon and posts the existence of that coupon on the user's page on the social network, preferably by a hypertext link or specific code recognized by the central server as associated with that specific user site or the originator's (coupon creator's) user site. Friends or contacts on that social network then access the coupon source through the hypertext link or code, and order the coupon. The central server identifies all coupons purchased through a user site rally and maintains an accounting of the coupons purchased through that rally. Importantly, however, the central server tracks the coupons purchased through each rally and identifies when or if those coupons are exercised in an actual purchase, whether on-line or through a brick and mortar business. As each coupon has a specific and unique identification mode (e.g., an identification number, code, serial number, bar code, frame code, etc.), the individual coupons, which have been associated with specific user sites, can be readily tracked. The account maintained by the central server for a user site has coupons purchased through that site's rally associated with that site account, but no economic benefit (cash award, additional discounts or any other economic benefit) is actually accrued or deposited into that account until coupons are exercised in effecting a purchase or trade. At a minimum, no credit for third party coupon ordering provides an economic benefit to the rally creator account until and unless a coupon is actually used in a purchase or trade. The user account will receive credit only for redeemed coupons. The system may optionally require that the coupon creator site also redeem its own created coupon for receiving economic benefit from at least the initial creation of the coupon and possibly even for third party coupon redemption through the user's site of coupons tied to the user account.

For example, consider the following sequence of steps. User site A establishes a coupon for X product through the central server. The central server establishes a user specific, coupon specific account, such as Site A, Coupon 1, Product X. 1000 third party users acquire these coupons. One of the third party coupon acquirer (at user site B) puts the coupon on his social network and directs a hypertext connection to the main server from his social network. 300 fourth party user sites obtain Coupon I through the social network hypertext link. The following scenarios could occur under the system described herein.

User site A has an accounting of 1001 coupons in a user site A account maintained by the social server (the user A coupon plus the 1000 coupons acquired through that site). User site B has an account in the central server for 300 coupons, that user site B's original coupon having been acquired through user site A. The 300 coupons of user site B are NOT accredited to user site A. If no coupons are redeemed, neither site A nor site B receives any economic benefit. If 400 of the coupons from user site A are redeemed, the user site A account will be credited with the economic benefit established under the system for redemption of coupons in a rally (e.g., 2% of the sales price in exercise of the coupon) for each coupon actually redeemed. The system MAY require that the site A original coupon be exercised to receive this accounting economic benefit.

120 of the site B originated coupons are redeemed. The user site B account will be credited with the economic benefit established under the system for redemption of coupons in a rally (e.g., 1%, 1.5% or 2% of the sales price in exercise of the coupon) for each coupon actually redeemed. The percentage for the “extended rally” (a rally piggy-backed onto an original rally) may be lower than the percentage for the original rally creator (to lower the incentive for ‘pirating’ rallies of others) or may be the same as for the original rally creator. In theory the piggy-back rally rate could be higher than the originator percentage, but this is disadvantageous to the concept of using originators and rewarding them.

During the time of coupon redemption the users ID may be associated with the coupons unique identifier (e.g., barcode or QR code) for tracking or for one time use purposes.

A customer that creates or joins a rally and shares the rally with its acquaintances is paid a percentage of the commission based on the transaction of the product or service to them and their followers. This percentage range is determined by the seller and/or coupon manager system executed by the central server. The range may be as small as (0.001% up to 5% or more, for example.

The Central Server is provided by a coupon provider or coupon manager organization, and an account/balance is defined for each user or joiner. All coupon transactions should or be used/implemented in a purchase transaction for accounting benefit (credit). Purchase may be on-line or POS (e.g., brick-and-mortar). The system may, before exercise of the site user A's originating coupon. keep the number of coupons acquired through a user site confidential or may relay that information to the site user A. If the information is kept confidential and the site user A must redeem its own coupon prior to being accredited economic benefit for the site derivative coupons, this will act as an incentive for the site user A to redeem its own coupon.

The customer (site user A) may have to redeem the coupon himself/herself that they created or joined in order to be eligible for the full (any) commission. Full disclosure of the commission generated by the customers may or may not be disclosed while the creator/rally participant coupon is active. In either case after the coupon expires the total amount of commissions earned by the individual customer will be displayed as a gain or loss (or potential commission) based on the customer's ability to redeem the coupon.

While the coupon is active these key features may or may not be displayed for the user during the redemption process: “Active” or “Close” status next to each coupon displayed. Current number of that user's followers that redeemed the coupon. And a active clock displaying the amount of time left before coupon expires.

Although this disclosure has specific content with regards to time frames, materials, components and the like, the claims should be interpreted as covering the generic concepts disclosed herein and not only the specific examples provided.

What is claimed:

1. A method of creating new on-line obtainable coupons comprising:
a first server enabling communication with a first class of third party on-line communicators;
the first server receiving proposed content on coupons from the first class of third party communicators;
the first server posting a list of the proposed coupons, with or without modification of the proposed coupons after receipt;
enabling access to a second class of third party communicators comprising businesses including at least vendors, stores, warehouses, and material suppliers;
allowing members of the second third party communicators to approve or disapprove of proposed coupons that are dedicated to business of the second third party communicator;
posting any second third party communicator approved coupons; and
allowing all on-line communicators access to approved coupons so that any of on-line communicators may access downloadable or printable forms of approved coupons
wherein the first server:
a) establishes an account respecting individual third party on-line communicators;
b) the first server identifying all acquisitions of coupons associated with a specific individual third party on-line communicator; and
c) accrediting economic value to the account respecting individual third party on-line communicators when the coupons associated with the specific individual third party on-line communicator are redeemed.

2. The method of claim 1 wherein a coupon acquired by the specific individual third party on-line communicator must be redeemed before accrediting under c) is effected by the first server.

3. A computer readable medium that stores instructions, which when executed by a computer, causes the computer to deliver a coupon online, said instructions to the computer for:
storing information, into a coupon delivery system,
to specify at least one specific vendor and/or or product for a coupon,
to allow at least one computer to accept form at least one consumer a suggestion online for at least one specific coupon desired by the consumer,
to allow the at least one computer to accept approval by the specific vendor or distributor or manufacturer of the product authorization to enable online access to the specific coupon, and
to allow online access to the at least one computer to download a coupon or verify access to the coupon for a consumer
wherein the computer medium executes software to:
a) establishes an account respecting individual third party on-line communicators;
b) identify all acquisitions of coupons associated with a specific individual third party on-line communicator; and
c) accredit economic value to the account respecting individual third party on-line communicators when the coupons associated with the specific individual third party on-line communicator are redeemed.

4. The computer readable medium of claim 3 that executes code when a coupon acquired by the specific individual third party on-line communicator is redeemed before accrediting under c) is effected by the first server.

5. A method comprising:
storing information on at least one processor in a coupon providing system;
the information allowing:
a) at least one unavailable coupon proposed by a consumer or vendor;
b) allowing consumers to provide commentary on a perceived desirability of the unavailable coupon;
c) allowing a vendor, supplier or manufacturer of a product described in the coupon to authorize availability of the coupon; and
d) upon receipt of authorization by the vendor, supplier or manufacturer, enabling online access for a download of the coupon or storing verification of availability of the authorized coupon when accessed by or on behalf of a consumer;
wherein the computer:
i) establishes an account respecting individual third party on-line communicators;
ii) the computer identifying all acquisitions of coupons associated with a specific individual third party on-line communicator; and
iii) accrediting economic value to the account respecting individual third party on-line communicators when the coupons associated with the specific individual third party on-line communicator are redeemed.
